(19) United States
(12) Patent Application Publication
(10) Pub. No.: US 2006/0279233 A1
(43) Pub. Date: Dec. 14, 2006

(54) Device and method for detecting whether turn signal lamp is operated

(76) Inventor: Sunchae Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/208,734

(22) Filed: Aug. 23, 2005

(30) Foreign Application Priority Data
Jun. 10, 2005 (KR) 10- 2005-0049656

(51) Int. Cl. H05B 41/36

(52) U.S. Cl. 315/291

(57) ABSTRACT

The present invention relates to a device and method for detecting whether a turn signal lamp is operated. A device for detecting whether a turn signal lamp is operated according to the present invention for achieving the object of the present invention comprises (1) an electric power input unit for receiving electric power inputted directly or indirectly from an operating power supply for the turn signal lamp; (2) an AC signal detector connected to the electric power input unit to detect an AC component signal in the voltage of the power supply; (3) a filtering unit for extracting only a signal component having a predetermined period and amplitude from the AC component signal detected by the AC signal detector; and (4) an amplifier for amplifying the signal component extracted by the filtering unit.

### BACKGROUND OF THE INVENTION

1. Field of the Invention

The present invention relates to a device and method for detecting whether a turn signal lamp is operated. More particularly, on condition that it is not to be construed as limiting the scope of the present invention, the present invention relates to a device and method for detecting whether a turn signal lamp is operated as a criterion for identifying whether a driver's voluntary lane change is performed or an involuntary and hazardous lane change causing a traffic accident is performed, in a lane departure warning system.

2. Description of the Related Art

Conventionally, in order for a driver to directly identify whether a turn signal lamp is operated or to identify it through a device such as a telematics terminal provided to the driver for the purpose of assisting in checking internal conditions of a vehicle, there is a method in which the driver identifies it with the naked eye through a turn signal indicator provided on a dashboard arranged in front of a driver's seat, or a method in which a flickering sate of a turn signal lamp is transmitted to the telematics terminal or the like by modifying a wiring harness inside the vehicle such that the harness is directly connected to the turn signal lamp or has a detection wire or the like added to the turn signal lamp.

Meanwhile, there have been provided various kinds of devices for sensing and warning driver's drowsiness at the wheel. Particularly, such a device for sensing driver's drowsiness at the wheel is constructed to photograph images of the front of a vehicle and determine whether the vehicle departs from a lane. An example of such a device is disclosed in Korean Patent Nos. 0440386 and 0440387.

Particularly, it will be understood that in order to determine whether a driver changes a lane intentionally or departures unintentionally the lane due to driver's drowsiness or careless at the wheel in a device for determining driver's drowsiness through such image photographing, it is preferred to detect whether a turn signal lamp be operated and to apply the detection to the device.

In other words, this device is constructed to give no warning if a lane is changed under a condition where a turn signal lamp is operated and flickered, and to determine that a driver unintentionally changes a lane if the lane is changed without operation of the turn signal lamp, whereby an unnecessary warning sound for a lane change is not generated. To this end, a signal for determining whether a turn signal lamp is operated should be acquired. In this case, a wiring harness connected to the turn signal lamp should be modified without any inventive studies.

However, the addition or modification of a wiring harness in this manner increases costs, and it is generally performed in a market after sale of a vehicle, i.e., so-called after-market. Thus, there is a risk that the addition or modification of wiring which was not considered upon design of original internal wiring of a vehicle may cause malfunction of electronic control devices installed within the vehicle.

Korean Utility Model Registration Application No. 1990-0004873 discloses a device for identifying lighting of a lamp of an automobile, wherein a detection wire is connected between two contacts spaced apart by a predetermined distance or more from each other on a line of a lamp circuit in the automobile, and a minute voltage difference between the two contacts that drops due to line resistance between the two contacts when an electric current is applied to the lamp is used as an input signal for an OP amplifier, so that an indicator lamp such as an LED can emit light when the lamp of the automobile is lighted and cannot emit light when the lamp is not energized. In such a prior art, it will be understood that a wiring harness should be inevitably modified to connect the detection wire between the two contacts on the line of the lamp circuit. Thus, it will be understood that most devices for checking the conditions of vehicles, e.g., telematics devices or the like, which are mounted inside vehicles at after-markets, are not appropriate to acquire information on determination as to whether a lamp of a vehicle is lighted.

### SUMMARY OF THE INVENTION

The present invention is conceived to solve the aforementioned problems. Accordingly, an object of the present invention is to provide a device and method for detecting whether a turn signal lamp is operated, wherein there is no need for adding or modifying a wiring harness inside a vehicle.

According to an aspect of the present invention for achieving the object, there is provided a device for detecting whether a turn signal lamp is operated, comprising: (1) an electric power input unit for receiving electric power inputted directly or indirectly from an operating power supply for the turn signal lamp; (2) an AC signal detector connected to the electric power input unit to detect an AC component signal in the voltage of the power supply; (3) a filtering unit for extracting only a signal component having a predetermined period and amplitude from the AC component signal detected by the AC signal detector; and (4) an amplifier for amplifying the signal component extracted by the filtering unit.

If a driver operates turn signal lamps using a multi-function switch provided in a vehicle, the turn signal lamps at the front and rear of the vehicle are flickered, and a minute voltage ripple of about 50 mV, which is an AC component of which the period is consistent with the flickering period of the turn signal lamps, is generated on a battery line of the vehicle. At this time, various kinds of noises are also included in the voltage ripple component in accordance with whether other electronic devices in the vehicle are operated.

Accordingly, the device for detecting whether a turn signal lamp is operated according to the present invention is conceived in consideration of this phenomenon. The device is constructed to detect whether the turn signal lamp is operated, by detecting only an AC component on the battery line so as to detect a minute voltage ripple generated on the battery line due to the operation of the turn signal lamp, and by extracting and amplifying only a signal having a predetermined period and voltage amplitude in the detected AC component. Since the operating electric power for the turn signal lamp is generally supplied from a battery uniquely provided in the vehicle, a voltage ripple applied to a power line of the battery is preferably measured in an embodiment of the present invention. However, if a plurality of power supplies are supplied to a vehicle depending on a configuration of a vehicle, it will be understood that a voltage ripple in a power supply for supplying operating electric power to the turn signal lamp is measured.

With this configuration, when the operating power supply such as a battery for the turn signal lamp is merely connected to the electric power input unit so that an electric current flows therebetween, a minute voltage ripple can be detected. Thus, there is no need for modifying electric wiring for the turn signal lamp or LED indicators or the like on a dashboard for indicating whether a turn signal lamp is operated, or adding an additional detection line, thereby greatly reducing costs for the installation of a device for detecting whether a turn signal lamp is operated, which is mostly performed in an after-market.

Preferably, the predetermined period is a period determined according to an operating period of the turn signal lamp.

As described above, the voltage ripple in the power line, which has passed through the AC signal detector, includes a various kinds of noises. At this time, since the voltage ripple due to the operation of the turn signal lamp is generated while conforming to the operating period of the turn signal lamp, the signal extracted by the filtering unit is preferably constructed to be determined depending on the operating period of the turn signal lamp, and more preferably, to have a period which is the same as or twice as large as the operating period of the turn signal lamp.

This configuration is advantageous in that the device for detecting whether the turn signal lamp is operated according to the present invention can be prevented from detecting erroneously whether the turn signal lamp is operated due to a signal having a noise component included in the power line of the vehicle.

Preferably, the device further comprises a square wave generator for converting a signal component amplified by the amplifier into a square wave.

Preferably, the device of the present invention further includes a square wave generator for converting a signal component amplified from the amplifier into a square wave.

In the device for detecting whether the turn signal lamp is operated according to the present invention, the amplified signal can be transmitted to an operating device, for example, a CPU so that it is possible to perform a predetermined operation using determination as to whether the turn signal lamp is operated. At this time, it is preferred that the signal component amplified by the amplifier be converted into a square wave so that the CPU can easily process the signal indicating whether the turn signal lamp is operated.

Preferably, the electric power input unit is connected to an electronic control device within a vehicle and receives electric power for operating the turn signal lamp from a power supply inspection terminal of an on-board diagnostic (OBD) connector or from a cigar jack provided to allow the electric power input unit to be connected thereto in a passenger room of the vehicle.

The device for detecting whether the turn signal lamp is operated according to the present invention may be included in an automobile on-board diagnostic information processing device disclosed in Korean Patent Application No. 10-2004-0030388. The automobile on-board diagnostic information processing device is plugged in the OBD connector, and electric power is supplied to the device through the OBD connector so that the device can determine whether the turn signal lamp is operated in accordance with whether the supplied electric power varies.

In addition to the method in which the electric power input unit is connected to the OBD connector as described above, it will be understood that since a power supply of a vehicle is configured to be always connected to a cigar jack, the power input unit can be connected to the cigar jack.

With this configuration, a voltage ripple signal in the power supply of a vehicle can be very easily acquired using a power outlet of a battery, which is provided in the vicinity of a driver's seat of the vehicle, among various examples of the power input unit for use in detecting the voltage ripple in the power supply.

Further, the device for detecting whether the turn signal lamp is operated according to the present invention may be included in an automobile lane departure warning device disclosed in Korean Patent Nos. 0440386 and 0440387 as described above.

According to another aspect of the present invention for achieving the object, there is provided a method for detecting whether a turn signal lamp is operated, comprising the steps of: (1) detecting an AC component signal in a voltage inputted from an operating power supply for the turn signal lamp; (2) filtering out and extracting a predetermined signal component having a characteristic determined depending on an operating period of the turn signal lamp and the amplitude of a voltage ripple in the operating power supply generated due to the operation of the turn signal lamp, from the detected AC component signal; and (3) amplifying the signal component extracted in the filtering step.

Preferably, the method further comprises the step of converting the signal amplified in the amplifying step into a square wave.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a circuit diagram of a device for detecting whether a turn signal lamp is operated according to the present invention;

FIG. 2 is a graph showing the generation of a flickering signal of a turn signal lamp, and a voltage ripple signal in electric power for operating the turn signal lamp;

FIG. 3 is an enlarged graph showing the voltage ripple signal in the operating electric power shown in FIG. 2;

FIG. 4 is a graph showing the voltage ripple signal in the operating electric power shown in FIG. 3, and a signal obtained by processing the voltage ripple signal through the device for detecting whether the turn signal lamp is operated according to the present invention; and

FIG. 5 is a graph showing the flickering signal and the signal obtained through the processing of the device for detecting whether the turn signal lamp is operated according to the present invention.

### DETAILED DESCRIPTION OF THE INVENTION

Hereinafter, a preferred embodiment of the present invention will be described in detail with reference to the accompanying drawings.

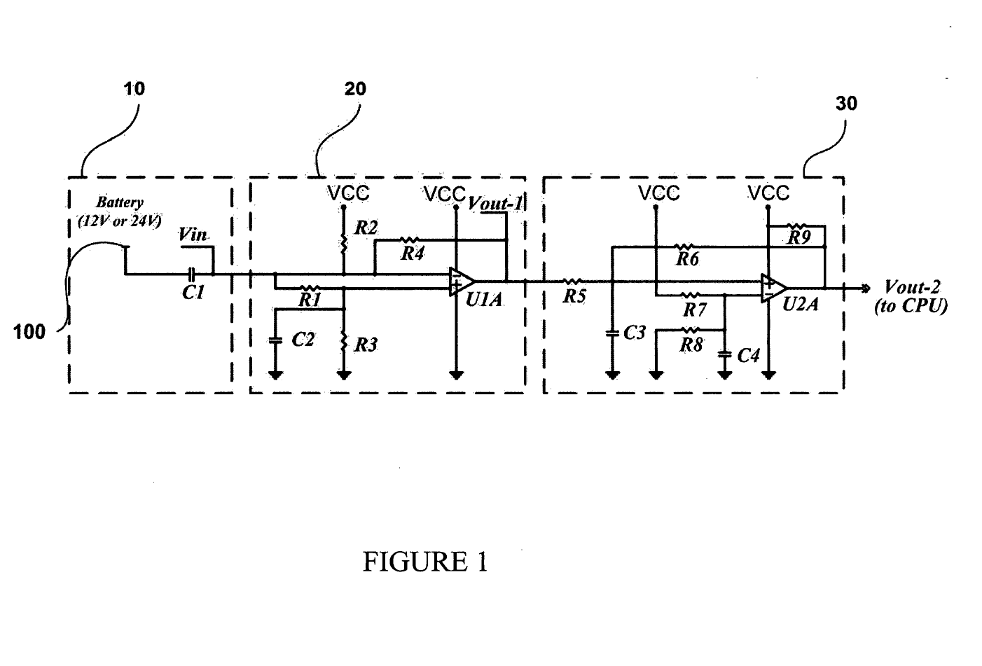

FIG. 1 is a circuit diagram of a device for detecting whether a turn signal lamp is operated according to the present invention.

As shown in FIG. 1, the device for detecting whether a turn signal lamp is operated according to the present invention comprises an electric power input unit 100 connected directly or indirectly to an operating power supply for supplying operating electric power to the turn signal lamp; a first circuit unit 10 including an AC signal detector with a first capacitor C1, as a circuit unit for detecting an AC component in a voltage of the operating electric power; a second circuit unit 20 for filtering out only a signal component having a predetermined period and voltage magnitude in a voltage ripple signal inputted and processed by the first circuit unit 10, and amplifying the filtered signal component; and a third circuit unit 30 for converting the signal component amplified by the second circuit unit into a square wave.

Particularly, it is preferred that the electric power input unit 100 be connected to a battery power supply (not shown) of the vehicle. More preferably, the electric power input unit 100 is constructed to be connected to an on-board diagnostic (OBD) connector (not shown) provided below a dashboard to receive electric power or to be connected to a cigar jack (not shown) to receive electric power. In such a preferred manner, it is possible to detect whether a turn signal lamp is operated, by sensing a voltage ripple in a power supply of a vehicle without addition or modification of a wiring harness for detecting whether a turn signal lamp is operated.

Although a power supply for operating electronic devices in a vehicle is a DC power supply, a voltage ripple generated due to operations of the electronic devices has an AC component. Thus, the AC signal detector having the first capacitor C1 for measuring such a voltage ripple is constructed to perform signal processing.

A voltage ripple component Vin from which a DC component is removed due to passage through the first capacitor C1 is filtered and amplified in the second circuit unit 20. Here, the filtering unit is constructed to remove, from voltage ripple components in the AC component, the remainder of the AC component except a voltage ripple component having a predetermined period and voltage amplitude determined according to a flickering period of a turn signal lamp.

The resistance and capacitance of a first resistor R1 and a second capacitor C2 are determined depending on design values. In this case, assuming that “V1” denotes an input voltage, “V2” denotes an output voltage, “t” denotes a time integer of a target AC component to be passed through by means of filtering, “R” denotes resistance, and “C” denotes capacitance, the resistance and capacitance are determined from the following Equation 1:

$$V 1 = V 2 \times EXP ( \frac{t}{RC} ) \qquad ( 1 )$$

Therefore, it is possible to design the resistance of the first resistor R1 and the capacitance of the second capacitor C2 depending on an input voltage, a target output voltage and a time integer of the output voltage in accordance with Equation 1.

The first resistor R1, a second resistor R2 and a third resistor R3 are resistors for distributed voltages that determine a reference input voltage of an OP amplifier U1A, and the resistance of each of the resistors R1, R2 and R3 can be determined in consideration of other design parameters. A fourth resistor R4 is a feedback resistor of the OP amplifier U1A and determines the amplification degree of an output voltage Vout-1 outputted from the second circuit unit 20.

In the second circuit unit 20, it is preferred that the reference voltage for inputting an input signal into the OP amplifier U1A and a voltage for operating the OP amplifier U1A be a voltage Vcc inputted from an electric power supply or an external electric power supply provided within the device for detecting whether a turn signal lamp is operated according to the present invention. Particularly, if the device for detecting whether a turn signal lamp is operated according to the present invention is included in a telematics terminal or an information terminal for a vehicle, it is preferred that the reference voltage and the operating voltage be inputted from an operating power supply for the telematics terminal or the information terminal. The reference voltage and the operating voltage are generally 3.3V or 5V.

Meanwhile, since a voltage ripple in a battery of a vehicle as an operating power supply, which is generated due to flickering of a turn signal lamp, is a minute voltage ripple of about 50 mV, it is preferred that a product having superior response speed and offset voltage characteristics be used for the OP amplifier of the second circuit unit 20.

The third circuit unit 30 is a Schmitt trigger signal processing circuit. In the third circuit unit 30, the Schmitt trigger circuit for noise margin design is provided to convert a voltage ripple component signal Vout-1, which has been processed by the second circuit unit 20, into an output signal Vout-2 that is a square wave for assisting a CPU to process a signal supplied to the telematics terminal or the information terminal including the device for detecting whether a turn signal lamp is operated according to the present invention.

The third circuit unit 30 is provided with a comparator U2A. It is preferred that the reference voltage and operating voltage thereof be also the voltage Vcc inputted from an electric power supply or an external electric power supply provided within the device for detecting whether a turn signal lamp is operated according to the present invention, in the same manner as the OP amplifier U1A.

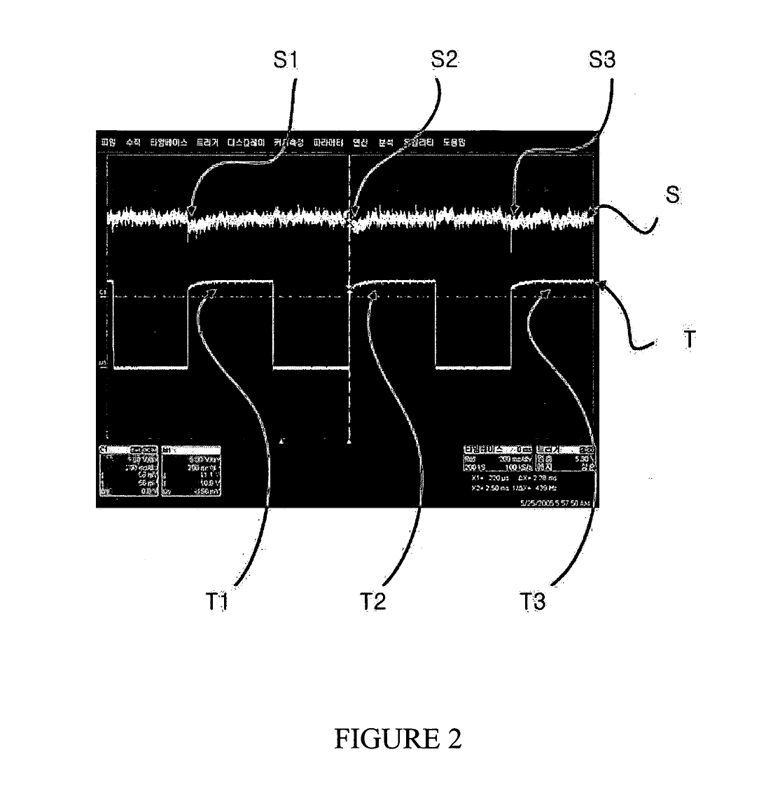

Voltage ripples in electric power for operating a turn signal lamp, which are produced due to generation of a flickering signal of the turn signal lamp, and the results obtained by causing the voltage ripples to be inputted into and processed by the device of the present invention will be described below with reference to FIGS. 2 to 5.

The abscissas of the graphs shown in FIGS. 2 to 5 are a time axis and the ordinates thereof are a voltage axis. In the graphs shown in FIGS. 2 to 5, line T denotes an operating voltage ripple line in a turn signal lamp in accordance with flickering of the turn signal lamp, line S denotes a voltage ripple line of an AC component signal from which a DC component is removed in a voltage ripple signal of a battery for supplying operating electric power to the turn signal lamp, and line M denotes a voltage ripple line of a signal that is obtained by causing the device of the present invention to filter out and amplify only a component having a predetermined period and voltage magnitude in the AC component signal. Referring again to FIG. 1 for better understanding of the graphs shown in FIGS. 2 to 5, it will be understood that line S is the voltage ripple component Vin obtained after the input voltage of the battery of the vehicle is processed by the first circuit unit shown in FIG. 1, and line M is a voltage ripple component Vout-1 obtained after the voltage ripple component Vin processed by the first circuit unit is processed by the second circuit unit shown in FIG. 1.

FIG. 2 is a graph showing the generation of a flickering signal of a turn signal lamp, and a voltage ripple signal in electric power for operating the turn signal lamp. As shown in FIG. 2, supply of a voltage to the turn signal lamp becomes ON/OFF at a predetermined interval in accordance with flickering thereof. According to such voltage ripples (ON/OFF) in the turn signal lamp, minute voltage ripples are produced in the voltage of a battery of a vehicle. In other words, it can be seen from FIG. 2 that there exist voltage ripples S1, S2 and S3 more significant than other minute voltage ripples on a voltage ripple line S, at the moment when the voltage of each period T1, T2 and T3 becomes ON in accordance with ON/OFF of the voltage for the turn signal lamp.

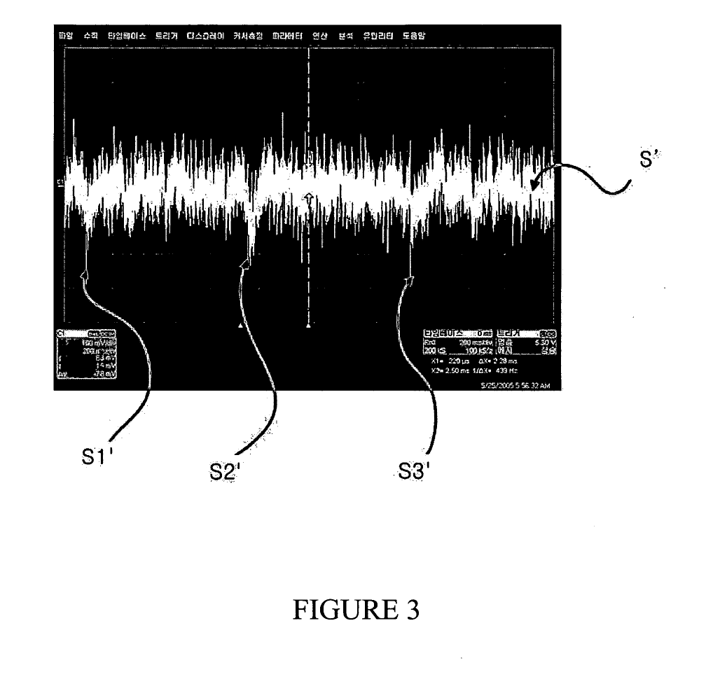

FIG. 3 is an enlarged graph showing the voltage ripple signal in the operating electric power shown in FIG. 2. As shown in FIG. 3, the graph of the voltage ripples in the operating electric power is a graph showing only the voltage ripple line S′ by reducing the voltage unit of the Y-axis so as to specifically examine the voltage ripple line S shown in FIG. 2. As can be seen in greater detail from FIG. 3, there exist voltage ripple points S1′, S2′ and S3′ at which voltage drop that is more remarkable than other voltage ripples are generated on the voltage ripple line S′, at the moment when the turn signal lamp becomes ON/OFF.

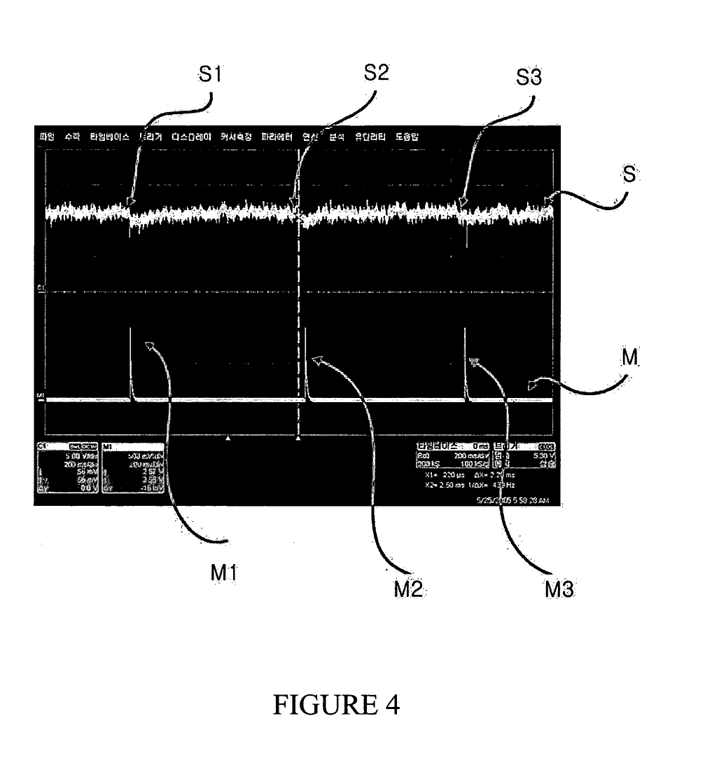

FIG. 4 is a graph showing the voltage ripple signal in the operating electric power shown in FIG. 3, and a signal obtained by processing the voltage ripple signal through the device for detecting whether the turn signal lamp is operated according to the present invention. As shown in FIG. 4, if the voltage of a battery of a vehicle, including various kinds of noises, are processed by the device for detecting whether a turn signal lamp is operated according to the present invention, predetermined signals M1, M2 and M3 can be obtained when the voltage ripple points S1, S2 and S3 appear as the turn signal lamp is turned on/off.

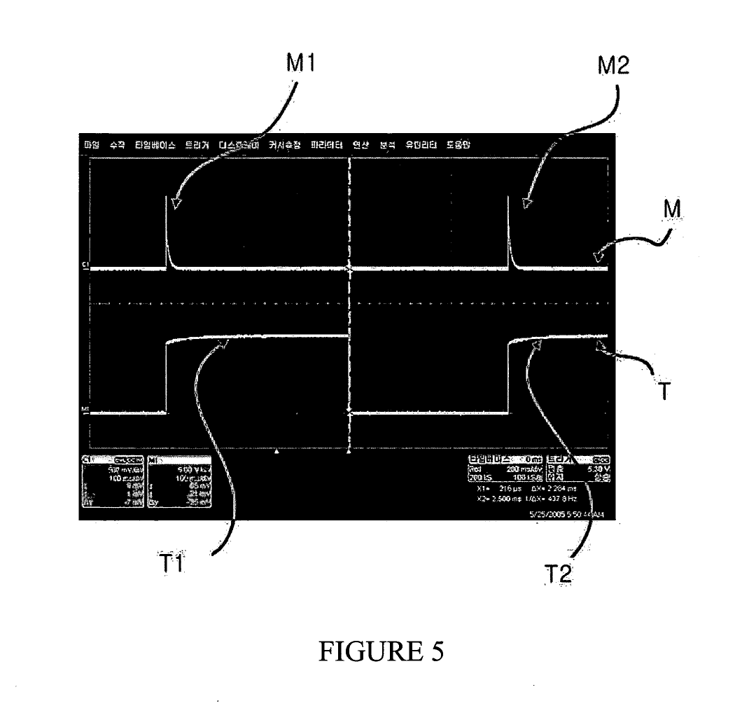

FIG. 5 is a graph showing the flickering signal and the signal obtained through the processing of the device for detecting whether the turn signal lamp is operated according to the present invention. A line drawn at a lower portion of FIG. 5 is line T showing voltage ripples in the turn signal lamp as the turn signal lamp is turned on/off, and a line drawn at an upper portion of FIG. 5 is line M showing a signal obtained after a signal inputted from a battery is processed by the device for detecting whether a turn signal lamp is operated according to the present invention. As shown in FIG. 5, the device for detecting whether the turn signal lamp is operated according to the present invention is constructed to generate predetermined signals M1 and M2 in accordance with flickering (ON/OFF) signals T1 and T2 of the turn signal lamp. The generation of the signals in this manner can be achieved by processing the battery voltage ripple signal having ripple lines shown in FIGS. 2 to 4. As described above, the signals M1 and M2 can be obtained by extracting only the AC component to extract a component resulting from a voltage ripple from the battery voltage ripple signal, filtering out a signal component having a period that is equal to or multiples of the operating period of the turn signal lamp to remove a noise component from the extracted AC component and to extract only a signal component in response to the flickering (ON/OFF) of the turn signal lamp, and amplifying the filtered signal component.

As described above, according to the present invention, it can be checked whether a turn signal lamp is operated, by measuring voltage ripples in a power supply, particularly a battery, for supplying operating electric power to the turn signal lamp. Further, since the measurement of the voltage ripples in the power supply can be performed without modification or addition of a wiring harness in a vehicle, there is no need for adding or modifying the wiring harness in the vehicle when providing a device and method for detecting whether a turn signal lamp is operated.

Although the present invention has been described in detail in connection with the preferred embodiment with reference to the accompanying drawings, it will be readily understood by those skilled in the art that various other modifications and changes can be made thereto without departing from the technical spirit and scope of the present invention. Thus, the embodiment of the present invention is illustrative and is not intended to limit the appended claims. The scope of the present invention is defined by the claims, and all changed and modified versions conceived from the meanings and scope of the claims and equivalents thereof should be construed as falling within the scope of the present invention.

1. A device for detecting whether a turn signal lamp is operated, the device comprising:
an electric power input unit for receiving electric power inputted directly or indirectly from an operating power supply for the turn signal lamp;
an AC signal detector connected to the electric power input unit to detect an AC component signal in the voltage of the power supply;
a filtering unit for extracting only a signal component having a predetermined period and amplitude from the AC component signal detected by the AC signal detector; and
an amplifier for amplifying the signal component extracted by the filtering unit.

2. The device as claimed in claim 1, wherein the predetermined period is a period determined according to an operating period of the turn signal lamp.

3. The device as claimed in claim 1, further comprising a square wave generator for converting a signal component amplified by the amplifier into a square wave.

4. The device as claimed in claim 1, wherein the electric power input unit is connected to an electronic control device within a vehicle and receives electric power for operating the turn signal lamp from a power supply inspection terminal of an on-board diagnostic (OBD) connector or from a cigar jack provided to allow the electric power input unit to be connected thereto in a passenger room of the vehicle.

5. A method for detecting whether a turn signal lamp is operated, the method comprising the steps of:
detecting an AC component signal in a voltage inputted from an operating power supply for the turn signal lamp;
filtering out and extracting a predetermined signal component having a characteristic determined depending on an operating period of the turn signal lamp and the amplitude of a voltage ripple in the operating power supply generated due to the operation of the turn signal lamp, from the detected AC component signal; and
amplifying the signal component extracted in the filtering step.

6. The method as claimed in claim 5, further comprising the step of converting the signal amplified in the amplifying step into a square wave.
